(19) United States
(12) Patent Application Publication
(10) Pub. No.: US 2025/0299019 A1
(43) Pub. Date: Sep. 25, 2025

(54) USING FEATURE PARTITIONING IN MACHINE LEARNING APPLICATIONS

(71) Applicant: Capital One Services, LLC, McLean, VA (US)

(72) Inventors: Ayaz MEHMANI, McLean, VA (US); Ruoyu SHAO, Allen, TX (US); John LUJANO, Dallas, TX (US)

(73) Assignee: Capital One Services, LLC, McLean, VA (US)

(21) Appl. No.: 18/614,418

(22) Filed: Mar. 22, 2024

(51) Int. Cl. G06N 3/045; G06N 3/084

(52) U.S. Cl. CPC G06N 3/045; G06N 3/084

(57) ABSTRACT

Methods and systems for identifying objects based on user-object interactions are disclosed. A system receives a prediction request and inputs parameters associated with the user into a first machine learning model to obtain a first set of object parameters based on a likelihood of interaction with each object based on dynamic features representative of recent user-element interactions. Similarly, the system may input the parameters associated with the user into a second machine learning model to obtain a second set of object parameters based on a likelihood of interaction by the user with each object based on stable features. The system identifies, based on the first and second sets of object parameters, one or more objects for the user and may provide the one or more objects to the user.

### SUMMARY

As technology advances and devices are more interconnected than ever before, an unprecedented amount of data and information is available to individuals regarding various aspects of their lives. Large amounts of data paired with greater processing power offers immense potential for making user-specific recommendations, such as in the realm of personalized medical treatment. For example, user-specific health data (e.g., genetic information, electronic health records, drug intake preferences) opens up the potential for highly individualized treatment plans tailored to patient-specific preferences that can make patient treatment more effective and comfortable. For example, based on a patient's priority for avoiding certain side effects over others, a choice in medication for an existing condition can help prevent unwanted situations for the patient.

Because of this, it is important for entities to be able to process the available data in an effective way to decrease the number of undesired outcomes in patients. However, many conventional systems only evaluate (e.g., process) the data available to them over a single, continuous period of time without giving focus to any samples specific to certain themes, such as specific times, cycles, focus parameters, etc. Processing such information by considering all samples in a nondiscriminatory manner can lead to the overlooking of specific, important factors regarding a patient that could impact the patient's health. For example, considering a patient's behavior or characteristics over their whole medical history can lead to an analysis that focuses heavily on long-term trends and can largely overshadow recent or more concentrated trends, which can be just as important, e.g., in diagnosing underlying causes and thus potential treatment as longer-term trends. Alternatively, considering just a shorter, more recent period of time can lead to missing out on a patient's long-term health history.

Accordingly, a mechanism is desired that would leverage both focused information specific to one or more identified themes (e.g., also referred to herein as focus parameters, concepts) and more stable, long-standing information for specific users in order to better provide recommendations for patients. One mechanism for doing so enables user selection of such themes and enables partitioning of user-specific features for identifying dynamic focusing on specific focus parameters and stable (e.g., reflecting foundational preferences) features using machine learning, which may enable systems to identify specific parameters that are important in considering a recommendation, e.g., for a medicine or product. For example, machine learning techniques can be used to process the parameters associated with a specific user to obtain different sets of parameters reflecting both a history of user-object interactions that are focused on selected themes as well as long-term history of a user's preference. The different sets may be used in combination to generate a recommendation for a user. Therefore, methods and systems are described herein for parameter focused partitioning of features using machine learning. A parameter focused partitioning system may be used to perform operations described herein.

In one example, the parameter focused partitioning system may receive previous records, such as records corresponding to previous prescription medication fills. The records may include features (e.g., columns or rows of data) indicative of user parameters (e.g., age, gender, known illnesses, etc. of a patient) and may also be indicative of corresponding user-element interactions, e.g., a patient's selection of a specific element of a user interface (UI) such as a click to fill the prescription for the medication. A user, such as an operator of a system or a warehouse or store manager, may select one or more focus parameters for which to identify object parameters for. The records may be split, e.g., based on the focus parameters that the user identified For example, a first subset of the set of features can include recent features having newer values recorded during a first segment of the period of time while a second subset of the set of features includes foundational features having older values recorded during a second segment of the period of time that is longer than the first segment of the period of time.

The parameter focused partitioning system may perform feature extraction using the first subset to obtain dynamic features representative of features that influenced user-element interaction corresponding to identified focus parameters and perform feature extraction using the second subset recorded during the second segment of the period of time to obtain stable features representative of features that influenced user-element interaction during a lengthier period of time that reflects a more holistic overview of the user's history. Two machine learning models may be trained on the first and second sets of features, such that when the system later receives a request for predicting one or more recommendations, e.g., for medications that are suitable for the patient, the system can utilize the output of the two machine learning models to identify one or more medications, or other objects, for a user.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data) unless the context clearly dictates otherwise.

### BRIEF DESCRIPTION OF THE DRAWINGS

FIG. 1 shows an illustrative system for identifying objects based on previous user-object interactions, in accordance with one or more embodiments of this disclosure.

FIG. 2 illustrates an exemplary data structure for one or more features of a record, in accordance with one or more embodiments of this disclosure.

FIG. 3 illustrates an exemplary set of dynamic and stable features, in accordance with one or more embodiments of this disclosure.

FIG. 4 illustrates an exemplary machine learning model, in accordance with one or more embodiments of this disclosure.

FIG. 5 illustrates an exemplary recommendation, in accordance with one or more embodiments of this disclosure.

FIG. 6 illustrates a computing device that can be used for identifying objects based on previous user-object interactions, in accordance with one or more embodiments of this disclosure.

FIG. 7 is a flowchart of operations for identifying objects based on previous user-object interactions, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

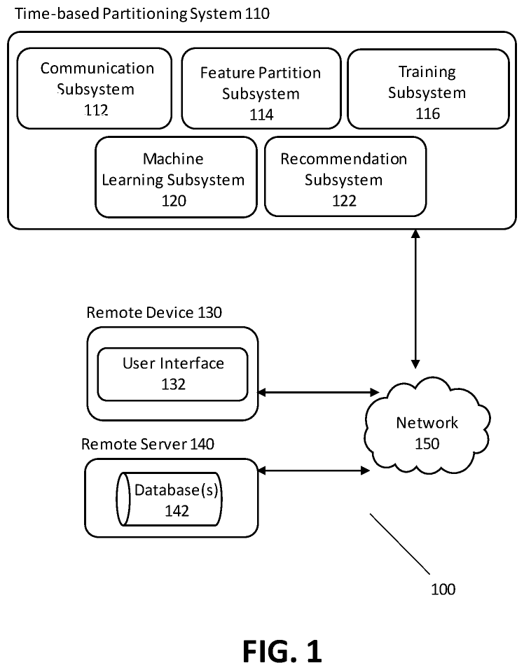

Environment 100 of FIG. 1 is an example system for identifying objects (e.g., for recommendation) based on previous user-object interactions, in accordance with one or more embodiments of this disclosure. Environment 100 includes parameter focused partitioning system 110, remote device 130, and remote server 140. Parameter focused partitioning system 110 may execute instructions for identifying objects based on previous user-element interactions. Parameter focused partitioning system 110 may include software, hardware, or a combination of the two. For example, parameter focused partitioning system 110 may be a physical server or a virtual server that is running on a physical computer system. In some embodiments, parameter focused partitioning system 110 may be configured on a user device (e.g., a laptop computer, a smartphone, a desktop computer, an electronic tablet, or another suitable user device).

Parameter focused partitioning system 110 may receive a prediction request for a user, such as a request to predict one or more objects to recommend to a user based on their interaction history with different elements, e.g., elements of a user interface. For example, the prediction request may consist of predicting one or more medications to suggest to a user based on features or parameters of their and/or similar users' interaction histories. Alternatively or additionally, the prediction request may consist of predicting one or more retail items to suggest, e.g., via an advertisement on a user device, based on parameters associated with the user. In some examples, the prediction request comprises parameters associated with the user.

The prediction request may also indicate one or more focus parameters for consideration. As referred to herein, a focus parameter may indicate a portion of the set of features for model concentration. For example, as discussed herein, a seller or store manager may select one or more focus parameters to focus analysis on by considering users' interaction histories with objects that are associated with the topic(s) or at times that are associated with the topic(s). For example, the topic may include a cyclical period of time, such as a holiday season (e.g., Christmas, Easter, Halloween, spring, etc.), or may relate to simply a recent period of time (e.g., within the past 24 hours). In some examples, the topic may simply be the items that the seller wishes to sell. For example, if a seller has too many toothbrushes in inventory, the seller may narrow the analysis by considering samples (e.g., user-interactions with objects) specific to toothbrushes.

Characteristics of the user may include, for example, information regarding the user that can be used to identify or classify the user as a type of user. For example, parameters associated with the user may include their age, gender, location, etc. The number of parameters associated with the user may depend on what is available or able to be determined based on the user's activity on the user device (e.g., remote device 130). For example, it may be determined that a user is of a certain age based on their input to their phone, applications accessed through their phone, etc.

In some embodiments, parameter focused partitioning system 110 may receive the request using communication subsystem 112. For example, parameter focused partitioning system 110 may receive the request from a user at a remote device 130 via user interface 132 or from database(s) 142 of remote server 140 via network 150. Network 150 may be a local area network (LAN), a wide area network (WAN; e.g., the internet), or a combination of the two. Communication subsystem 112 may include software components, hardware components, or a combination of both. For example, communication subsystem 112 may include a network card (e.g., a wireless network card and/or a wired network card) that is associated with software to drive the card. Communication subsystem 112 may pass at least a portion of the data included in the request, or a pointer to the data in memory, to other subsystems such as feature partition subsystem 114, training subsystem 116, machine learning subsystem 120, and/or recommendation subsystem 122.

As described, communication subsystem 112 may pass at least a portion of the data of the request, or a pointer to the data in memory, to machine learning subsystem 120. Machine learning subsystem 120 may input the parameters associated with the user into one or more machine learning models to obtain object (e.g., medication, product, etc.) parameters that can be used to recommend one or more products for users having the same or similar parameters associated with the user. Object parameters may include specific attributes or properties that define an object. For example, for objects such as medications, the object parameters may include attributes like a color, a weight, a dimension, price, whether or not they cause certain side effects, and/or a manufacturer or brand of the object. For objects in a retail setting, such as an online retail website, the object parameters may include tags or metadata that indicate attributes of the objects, such as type of object, size, brand, etc.

For example, machine learning subsystem 120 can be used to obtain a first and second set of object parameters based on dynamic features to identify object parameters associated with objects that users are likely to interact with based on recent user-element interactions and based on stable features to identify object parameters associated with the objects that the users are likely to interact with based on stable user-element interactions. Recommendation subsystem 122 may identify the objects to recommend to the user based on the object parameters from machine learning subsystem 120. The subsystem may then generate commands or instructions to be passed from recommendation subsystem 122 to communication subsystem 112. The commands or instructions can subsequently be transmitted from communication subsystem 112 via network 150 to a remote user device, e.g., remote device 130.

For example, recommendation subsystem 122 may identify a ranked list of the objects that are determined to have the highest likelihood of a user's interaction with an element (e.g., a personalized advertisement or recommendation) based on the object parameters of the object. Recommendation subsystem 122 may be configured to generate a command to create one or more user interaction elements such as an advertisement, a button to click, a recommendation list, etc. that is provided on the user interface 132 of a remote device 130. The communication subsystem may be used to transmit a command for generating and displaying an interactive interface for the one or more objects, e.g., including the one or more elements. In some examples, responsive to receiving an indication of an interaction of the user with an object of the one or more objects, communication subsystem 112 may transmit a command for modifying a field indicative of an availability of the object, e.g., to note that the medication or product is no longer available in an inventory. For example, in the case of an online retail website, the system may consider a user's likelihood of clicking on a recommended item that is displayed for the user, or putting the item in a cart, etc. once displayed.

Recommendation subsystem 122 may utilize the first and second sets of object parameters in various ways in order to identify the one or more objects to recommend or present to the user. For example, according to some examples, identifying the one or more objects for the user may include inputting the first set of object parameters and the second set of object parameters into a context-specific machine learning model configured to identify the one or more objects ranking highest according to their alignment with features from both the first set of object parameters and the second set of object parameters.

Alternatively or additionally, identifying the one or more objects may include receiving the first set of object parameters and the second set of object parameters and determining a set of objects, wherein each object of the set of objects is characterized by at least one object parameter comprised in both the first set of object parameters and the second set of object parameters. The recommendation subsystem may then compute, for each object of the set of objects, a score based on a number of object parameters of each object comprised in both the first set of object parameters and the second set of object parameters and identify a subset of the set of objects based on the score of each object.

Alternatively or additionally, identifying the one or more objects may include determining an object set based on objects characterized by at least one object parameter of the first set of object parameters and determining the one or more objects by filtering the objects of the object set based on whether or not each object of the object set is characterized by at least one object parameter of the second set of object parameters. In some examples, identifying the one or more objects includes determining a third set of object parameters based on object parameters comprised in both the first set of object parameters and the second set of object parameters and selecting the one or more objects based on each object of the one or more objects being characterized by at least a threshold number of object parameters of the third set of object parameters.

Alternatively or additionally, identifying the one or more objects may include determining the at least one object parameter of the first set of object parameters is distinct from object parameters of the second set of object parameters and selecting the one or more objects based on the objects characterized by a highest number of object parameters of the first set of object parameters and the second set of object parameters. Identifying the objects may involve using content-based, collaborative filtering, restricted Boltzmann, recurrent neural network, etc. to determine the sets of object parameters in each of the first and second machine learning models. By doing so, recommender systems with high volume items in bandwidth-constrained user environments can more effectively process high volumes of data when determining user preference by condensing the user preferences into machine learning model systems for specific types of users.

As described herein, one or more machine learning models may be executed to obtain the object parameters. In some examples, the one or more machine learning models may be trained on a remote device (e.g., remote device 130) and/or stored on a remote server (e.g., remote server 140) and obtained via communication subsystem 112. In this example, the machine learning subsystem executes the one or more machine learning models in machine learning subsystem 120. Alternatively or additionally, the system may train the machine learning model(s). For example, the system may obtain training data via communication subsystem 112 and parse the data, e.g., using feature partition subsystem 114. The system may then use training subsystem 116 to train one or more machine learning models on the parsed data.

For example, communication subsystem 112 may obtain records, e.g., from local storage, from a remote device 130, and/or database(s) 142 of remote server 140. In one embodiment, communication subsystem 112 may transmit a request for accessing the records. Alternatively or additionally, communication subsystem 112 may receive the records without otherwise requesting the records. For example, the remote device, database, or other custodian of data may transmit one or more records intermittently or stream the data continuously.

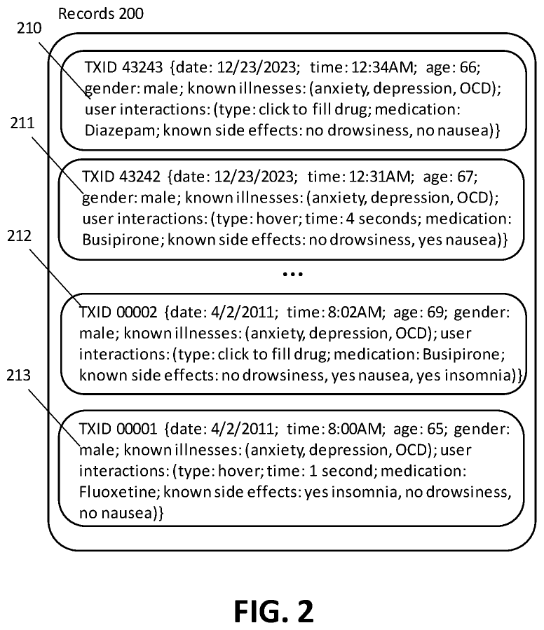

The plurality of records may include a set of features indicative of (a) user parameters for a plurality of users and (b) corresponding user-element interactions for each user parameter recorded during a period of time. The plurality of records may also include (c) a focus parameter. Each feature may include a plurality of values with each value corresponding to a record of the plurality of records. For example, a feature may take the form of a row or column in a tabular dataset, or may be a separate data structure. In some examples, a feature may include a vector. For example, FIG. 2 illustrates an exemplary data structure for one or more features of a record, in accordance with one or more embodiments of this disclosure. FIG. 2 includes records 200 such as record 210, record 211, record 212, and record 213. Each of the records may include values for features such as “date,” “time,” “age,” “gender,” “known illnesses,” “user interactions,” “type,” and “known side effects.” In a retail shopping setting, the system may consider features such as estimated income, amount purchased, age, location, and/or the like. In some examples, the superset of features having values in each of the records may be considered the set of features. Alternatively or additionally, the features having values defined in each of the records can also be considered the set of features.

Communication subsystem 112 may pass the records, e.g., record 210, record 211, record 212, and record 213, to feature partition subsystem 114 where the system partitions the features, e.g., generates subsets of features. In particular, feature partition subsystem 114 may partition the features into a first subset of the set of features made up of concentrated features associated with a selected topic and a second subset of the set of features made up of foundational features, e.g., features that are representative of all user-interactions, or a broader range than those in the first subset. The second subset of the set of features may include, for example foundational features having values recorded over time that provide a baseline for a training dataset. For example, feature partition subsystem 114 may split the feature “known side effects” into two groups of values for the feature, such as a first group including the values for the feature “known side effects” of record 210 and record 211 and a second group including the values for the same feature of record 212 and record 213. The partitioning may be performed based on whether or not the records have certain tags indicative of association with certain focus parameters. For example, if the topic is “springtime,” than the system may identify records having a tag identifying the topic “springtime” or it may identify the records based on the timestamps of the records (e.g., if the timestamp is within a defined time for spring). For example, record 210 and record 211 have timestamps specified by “date: 12/23/2023; time: 12:34 AM” and “date: 12/23/2023; time: 12:31 AM,” respectively. Similarly, record 212 and record 213 have timestamps specified by “date: 4/2/2011; time: 8:02 AM” and “date: 4/2/2011; time: 8:00 AM,” respectively. In some examples, the partition subsystem may further partition based on a type of user.

Although a first subset is described here with respect to one set of dynamic features associated with one topic, many subsets can be determined, where each subset corresponds to a set of dynamic features. Each subset can be determined using the methods described herein, e.g., based on time, based on tags that identify the topic, using techniques such as filtering, comparing, etc.

As described herein, in one example, the generation of the subsets may include partitioning based on a specified timestamp. In other examples, however, multiple subsets may be generated based on various tags on the records (e.g., by filtering based on tags). In some examples, the specific point at which to split the records (e.g., the records having values for the features to consider in each of the first and second subset) can be determined based on a fractional amount. For example, if the number of total records is 43,243, the values to be included in the first subset to reflect recent user-element interactions may be identified based on a predetermined fraction, such as the most recent fifth of the number of records. As such, the system may include the values of feature “known side effects,” as well as values of the other features, for the records having transaction identifiers 33694 to 43243. Similarly, the values of features to be included in the second subset may include all records throughout the user history that are accessible to the system, or may be capped to a predetermined number of records, e.g., only the past 50,000 records.

Feature partition subsystem 114 may further perform feature extraction using the subsets. For example, feature partition subsystem 114 may use the first subset to obtain dynamic features representative of features that influenced user-element interaction associated with the topic selected by a user (e.g., seller, warehouse manager, etc.) and similarly perform feature extraction using the second subset recorded during the second segment of the period of time to obtain stable features representative of features that influenced user-element interaction foundationally, over a broader sample set.

In the example of FIG. 2, the system may use the first subset of features, e.g., including the values of record 210 and record 211, to identify and obtain dynamic features representative of features that influenced user-element interaction associated with the topic selected by a user (e.g., seller, warehouse manager, etc.). For example, considering record 210 having feature values “{date: 12/23/2023; time: 12:34 AM; age: 66; gender: male; known illnesses: (anxiety, depression, OCD); user interactions: (type: click to fill drug; medication: Diazepam; known side effects: no drowsiness, no nausea)}” and record 211 having feature values “{date: 12/23/2023; time: 12:31 AM; age: 67; gender: male; known illnesses: (anxiety, depression, OCD); user interactions: (type: hover; time: 4 seconds; medication: Busipirone; known side effects: no drowsiness, yes nauesea)},” the feature extraction process may identify that trends in user-element interactions (e.g., how or how long a user interacts with an element of a user interface) associated with the topic “winter” show that users of the same age group and gender with the same known illnesses prefer medications with no nausea in the wintertime. For example, the system may determine that one of the largest feature values that influenced a user's decision to click to fill a prescription for a specific medication included whether or not the medication caused nausea.

Similarly, considering record 212 having feature values “{date: 4/2/2011; time: 8:02 AM; age: 69; gender: male; known illnesses: (anxiety, depression, OCD); user interactions: (type: click to fill drug; medication: Busipirone; known side effects: no drowsiness, yes nausea, yes insomnia)}” and record 213 having feature values “{date: 4/2/2011; time: 8:00 AM; age: 65; gender: male; known illnesses: (anxiety, depression, OCD); user interactions: (type: hover; time: 1 second; medication: Fluoxetine; known side effects: yes insomnia, no drowsiness, no nausea)},” the feature extraction process may identify that over historic periods of time, features that consistently influenced a user's decision to click to fill a prescription for a specific medication included whether or not the medication caused drowsiness, e.g., since the user only interacted with elements associated with medications that do not cause drowsiness.

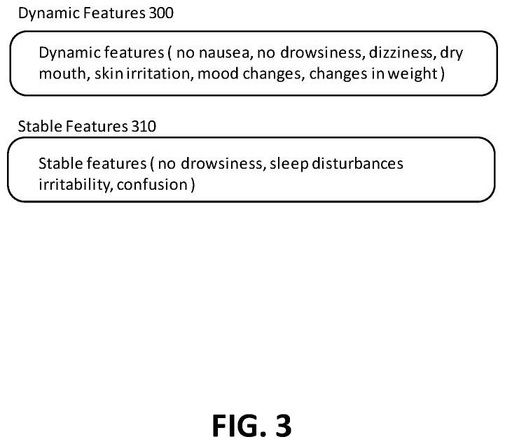

The extracted features may be stored, e.g., in a vector or other data structure. For example, FIG. 3 illustrates an exemplary data structure for a set of dynamic and stable features, in accordance with one or more embodiments of this disclosure. For example, dynamic features 300 includes feature values “no nausea” and “no drowsiness” to indicate that one of the largest feature values that recently influenced a user's decision to click to fill a prescription for a specific medication included whether or not the medication caused nausea and/or drowsiness, among other features and feature values. Similarly, stable features 310 includes the feature values of “no drowsiness” to indicate that one of the largest feature values that influenced a user's decision throughout, for example throughout a whole interaction history of a user and/or user type, included whether or not the medication caused drowsiness, among other features and feature values.

As described herein, the dynamic features and/or the stable features can be used to train one or more machine learning models to identify object parameters that users are likely to interact with based on recent user-element interactions. For example, a first machine learning model may be trained using the dynamic features of the first subset of the set of features to identify object parameters associated with objects that users are likely to interact with based on recent user-element interactions and a second machine learning model may be trained using the stable features of the second subset of the set of features to identify object parameters associated with the objects that the users are likely to interact with based on stable user-element interaction.

As described herein, there may be multiple machine learning models corresponding to dynamic features for different subsets of features that are associated with multiple different focus parameters selected by a seller, for example. A seller may want to consider features that should be used to understand purchases made in the winter, specifically for men, and where the user interactions occurred at night. In this example, the system may determine four subsets in total, three corresponding to dynamic features and one for stable features. The system may determine samples (e.g., records, user interactions) to identify dynamic features associated with user interactions corresponding to the topic “winter” by considering either the date on the timestamp and/or using a tag identifying it as a “winter” interaction. The system may determine samples (e.g., records, user interactions) to identify dynamic features associated with user interactions corresponding to the topic “men” by considering either the name or a tag identifying the interaction as being performed by a man. The system may determine samples (e.g., records, user interactions) to identify dynamic features associated with user interactions corresponding to the topic “night” by considering either the time on the timestamp and/or using a tag identifying it as a “night” interaction. Then three separate machine learning models may be trained to each identify object parameters associated with each topic.

The second machine learning model may be intended to be refit less frequently than the first machine learning model, according to some embodiments. In some examples, the predictions of the first machine learning model can either be used as offset or post-processed by the predictions of the second machine learning model, or vice versa.

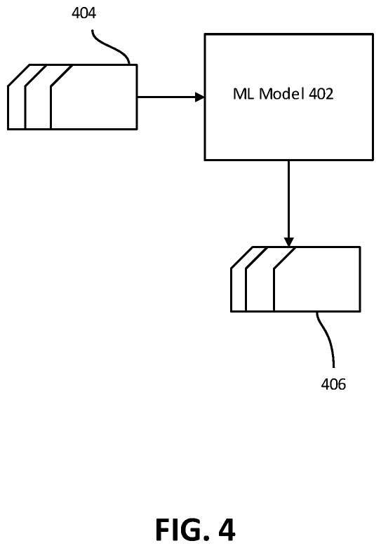

FIG. 4 illustrates an exemplary machine learning model 402 (e.g., the first and/or second machine learning model). According to some examples, the machine learning model may be a model configured to identify object parameters associated with objects that users are likely to interact with based on recent user-element interactions and/or based on stable user-element interaction. For example, the machine learning model may be trained to intake user parameters as input 404, such as age, gender, location, etc., and identify object parameters associated with objects such as products and/or medications that the user would be likely to interact with, e.g., if it were provided as part of a user interface element, e.g., on a remote device, as output 406. The machine learning model may have been trained on a training dataset containing a plurality of user parameters and corresponding dynamic and stable features. An exemplary machine learning model is described in relation to FIG. 4 herein.

The output parameters may be fed back to the machine learning model as input to train the machine learning model (e.g., alone or in conjunction with user indications of the accuracy of outputs, labels associated with the inputs, or other reference feedback information). The machine learning model may update its configurations (e.g., weights, biases, or other parameters) based on the assessment of its prediction (e.g., of an information source) and reference feedback information (e.g., user indication of accuracy, reference labels, or other information). Connection weights may be adjusted, for example, if the machine learning model is a neural network, to reconcile differences between the neural network's prediction and the reference feedback. One or more neurons of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the machine learning model may be trained to generate better predictions of information sources that are responsive to a query.

In some embodiments, the machine learning model may include an artificial neural network. In such embodiments, the machine learning model may include an input layer and one or more hidden layers. Each neural unit of the machine learning model may be connected to one or more other neural units of the machine learning model. Such connections may be enforcing or inhibitory in their effect on the activation state of connected neural units. Each individual neural unit may have a summation function that combines the values of all of its inputs together. Each connection (or the neural unit itself) may have a threshold function that a signal must surpass before it propagates to other neural units. The machine learning model may be self-learning and/or trained rather than explicitly programmed and may perform significantly better in certain areas of problem solving as compared to computer programs that do not use machine learning. During training, an output layer of the machine learning model may correspond to a classification of the machine learning model, and an input known to correspond to that classification may be input into an input layer of the machine learning model during training. During testing, an input without a known classification may be input into the input layer, and a determined classification may be output.

A machine learning model may include embedding layers in which each feature of a vector is converted into a dense vector representation. These dense vector representations for each feature may be pooled at one or more subsequent layers to convert the set of embedding vectors into a single vector. The machine learning model may be structured as a factorization machine model. The machine learning model may be a non-linear model and/or supervised learning model that can perform classification and/or regression. For example, the machine learning model may be a general-purpose supervised learning algorithm that the system uses for both classification and regression tasks. Alternatively, the machine learning model may include a Bayesian model configured to perform variational inference on the graph and/or vector.

In some embodiments, training subsystem 116 may train the machine learning model. Training subsystem 116 may receive a dataset (e.g., from database(s) 142 of remote server 140) that includes a plurality of records, e.g., as described herein in relation to FIG. 2. Each of the records may include values of features that can be partitioned into two sets based on time at feature partition subsystem 114 and then used to train the models at training subsystem 116. For example, the records may each have timestamps and may be partitioned as part of one or both of the sets based on whether the timestamp falls between a start and end timestamp that defines each set. Training subsystem 116 may pass the parameters of the trained models to machine learning subsystem 120 where the parameters may be stored until the models are executed. Machine learning subsystem 120 may receive a prediction request for a user including parameters associated with the user and may input the parameters associated with the user into a first machine learning model to obtain a first set of object parameters based on a measure of likelihood of interaction by the user with each object corresponding to the first set of object parameters based on dynamic features and input the parameters associated with the user into a second machine learning model to obtain a second set of object parameters based on a measure of likelihood of interaction by the user with each object corresponding to the second set of object parameters based on stable features. Machine learning subsystem 120 may, as described herein, pass the first and second sets of object parameters to recommendation subsystem 122. Recommendation subsystem 122 may, as described herein, identify one or more objects, e.g., to recommend or present to the user. For example, recommendation subsystem 122 may identify the objects based on the first set of object parameters and the second set of object parameters using a combined determination based on alignment of object features associated with the one or more objects with predicted features from the first set of object parameters and the second set of object parameters.

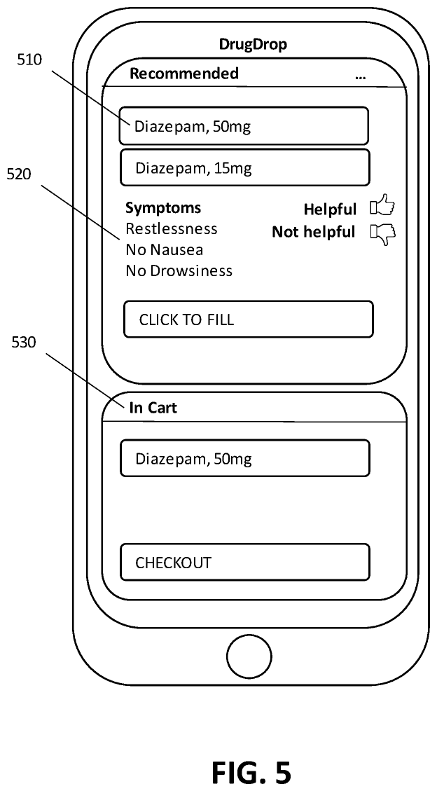

For example, FIG. 5 illustrates an exemplary recommendation, e.g., on a user device, in accordance with one or more embodiments of this disclosure. The exemplary recommendation may include an object for recommending and/or presenting to the user based on the sets of object parameters. In the example of FIG. 5, the one or more objects 510 may include “Diazepam.” In some examples, the features associated with the object 520 may be presented to the user on the user interface as well, e.g., as part of the recommendation. When a user interacts with the element corresponding to the user interface, such as by clicking it, hovering over it, adding it to cart 530, and/or purchasing it, the availability of the object may be updated, e.g., such as to identify the object as being reserved, no longer available for others to purchase, and/or the like.

According to some examples, a user interface used to present the object(s) to the user may also identify an explanation for why a particular object was presented to the user. The system may use explainability methods such as SHAP, LIME, Permutation Importance, Partial Dependence Plot, Morris Sensitivity Analysis, Accumulated Local Effects (ALE), Anchors, Contrastive Explanation Method (CEM), Counterfactual Instances, Integrated Gradients, Global Interpretation via Recursive Partitioning (GIRP), Protodash, Scalable Bayesian Rule Lists, Tree Surrogates, Explainable Boosting Machine (EBM). Explainability may be performed on one or more machine learning models (e.g., any combination of the model corresponding to stable features and the one or more models corresponding to dynamic features). In some examples, the explanation may be presented to the user responsive to the user hovering over an object listing, or a report may be transmitted to a user device.

### Computing Environment

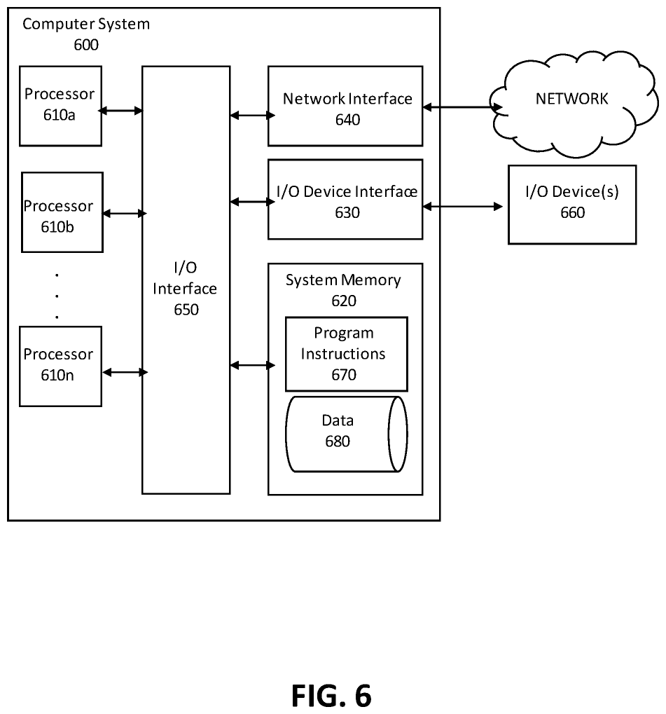

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and I/O operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the internet, a LAN, a WAN, a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600 or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

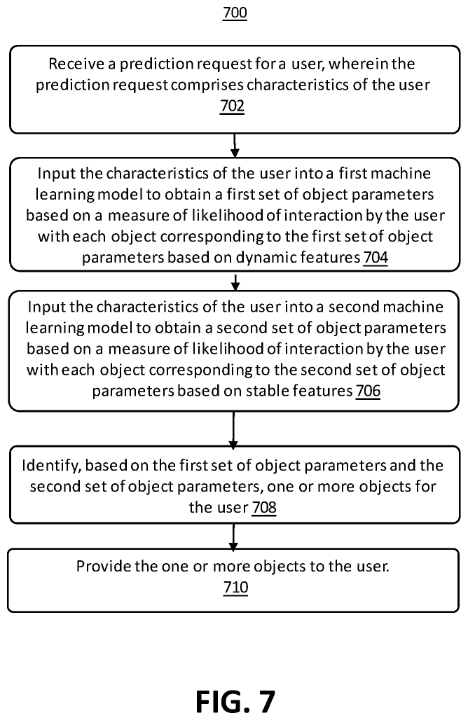

FIG. 7 is a flowchart 700 of operations for identifying objects based on previous user-object interactions, in accordance with one or more embodiments of this disclosure. The operations of FIG. 7 may use components described in relation to FIG. 6. In some embodiments, parameter focused partitioning system 110 may include one or more components of computer system 600.

At 702, parameter focused partitioning system 110 receives a prediction request for a user, wherein the prediction request comprises parameters associated with the user. Parameter focused partitioning system 110 may receive the request over network 150 using network interface 640. For example, the parameter focused partitioning system may receive a prediction request for a user that includes parameters associated with the user that identify the user as a user type, e.g., including parameters such as age, gender, location, etc.

At 704, parameter focused partitioning system 110 inputs the parameters associated with the user into a first machine learning model to obtain a first set of object parameters based on a measure of likelihood of interaction by the user with each object corresponding to the first set of object parameters based on dynamic features. Parameter focused partitioning system 110 may use one or more processors 610a, 610b, and/or 610n to perform the obtaining.

At 706, parameter focused partitioning system 110 inputs the parameters associated with the user into a second machine learning model to obtain a second set of object parameters based on a measure of likelihood of interaction by the user with each object corresponding to the second set of object parameters based on stable features. For example, parameter focused partitioning system 110 may use one or more processors 610a-610n to perform the operations and may store the results in system memory 620.

At 708, parameter focused partitioning system 110 identifies, based on the first set of object parameters and the second set of object parameters, one or more objects for the user. For example, the system may utilize the first and second sets of object parameters in various ways in order to identify the one or more objects to recommend or present to the user. For example, according to some examples, identifying the one or more objects for the user may include inputting the first set of object parameters and the second set of object parameters into a context-specific machine learning model configured to identify the one or more objects ranking highest according to their alignment with features from both the first set of object parameters and the second set of object parameters.

Alternatively or additionally, identifying the one or more objects may include receiving the first set of object parameters and the second set of object parameters and determining a set of objects, wherein each object of the set of objects is characterized by at least one object parameter comprised in both the first set of object parameters and the second set of object parameters. The recommendation subsystem may then compute, for each object of the set of objects, a score based on a number of object parameters of each object comprised in both the first set of object parameters and the second set of object parameters and identify a subset of the set of objects based on the score of each object.

Alternatively or additionally, identifying the one or more objects may include determining an object set based on objects characterized by at least one object parameter of the first set of object parameters and determining the one or more objects by filtering the objects of the object set based on whether or not each object of the object set is characterized by at least one object parameter of the second set of object parameters. In some examples, identifying the one or more objects includes determining a third set of object parameters based on object parameters comprised in both the first set of object parameters and the second set of object parameters and selecting the one or more objects based on each object of the one or more objects being characterized by at least a threshold number of object parameters of the third set of object parameters.

Alternatively or additionally, identifying the one or more objects may include determining the at least one object parameter of the first set of object parameters is distinct from object parameters of the second set of object parameters and selecting the one or more objects based on the objects characterized by a highest number of object parameters of the first set of object parameters and the second set of object parameters.

At 710, parameter focused partitioning system 110 provides the one or more objects to the user. Recommendation subsystem 122 may be configured to generate a command to create one or more user interaction elements such as an advertisement, a button to click, a recommendation list, etc. that is provided on the user interface 132 of a remote device 130. Communication subsystem 112 may be used to transmit a command for generating and displaying an interactive interface for the one or more objects, e.g., including the one or more elements. In some examples, responsive to receiving an indication of an interaction of the user with an object of the one or more objects, communication subsystem 112 may transmit a command for modifying a field indicative of an availability of the object, e.g., to note that the medication or product is no longer available in an inventory.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method for identifying objects based on previous user-object interactions, the method comprising: receiving a prediction request for a user, wherein the prediction request comprises parameters associated with the user; inputting the parameters associated with the user into a first machine learning model to obtain a first set of object parameters based on a measure of likelihood of interaction by the user with each object corresponding to the first set of object parameters based on dynamic features, wherein the first machine learning model is trained using the dynamic features to identify object parameters associated with the objects that users are likely to interact with based on user-element interactions corresponding to a focus parameter, wherein the focus parameter indicates a portion of a set of features for model concentration; inputting the parameters associated with the user into a second machine learning model to obtain a second set of object parameters based on the measure of the likelihood of interaction by the user with each object corresponding to the second set of object parameters based on stable features, wherein the second machine learning model is trained using the stable features to identify the object parameters associated with the objects that the users are likely to interact with based on stable user-element interactions; identifying, based on the first set of object parameters and the second set of object parameters, one or more objects for the user, wherein the one or more objects are identified using a combined determination based on alignment of object features associated with the one or more objects with predicted features from the first set of object parameters and the second set of object parameters; and providing the one or more objects to the user.
2. The method of the preceding embodiment, further comprising: transmitting a first command for generating and displaying an interactive interface for the one or more objects; and responsive to receiving an indication of a first interaction of the user with an object of the one or more objects, transmitting a second command for modifying a field indicative of an availability of the object.
3. The method of any of the preceding embodiments, wherein the dynamic features and the stable features are obtained through feature extraction comprising: receiving a plurality of records comprising a set of features indicative of (a) user parameters for a plurality of users, (b) corresponding user-element interactions for each user parameter recorded during a period of time, wherein each feature comprises a plurality of values with each value corresponding to a record of the plurality of records, and (c) the focus parameter; generating from the set of features (1) a first subset of the set of features, the first subset comprising concentrated features associated with focus parameter and generating from the set of features (2) a second subset of the set of features, the second subset comprising foundational features having values recorded over time that provide a baseline for a training dataset; and performing feature extraction using the first subset to obtain dynamic features representative of features that influenced user-element interactions associated with the focus parameter and performing the feature extraction using the second subset to obtain stable features representative of the features that influenced the user-element interactions that are non-specific to any one topic.
4. The method of any of the preceding embodiments, further comprising: training a first machine learning model using the dynamic features of the first subset of the set of features to identify object parameters associated with the objects that users are likely to interact with based on user-element interactions associated with the focus parameter; and training a second machine learning model using the stable features of the second subset of the set of features to identify the object parameters associated with the objects that the users are likely to interact with based on stable user-element interactions.
5. The method of any of the preceding embodiments, wherein identifying the one or more objects for the user comprises inputting the first set of object parameters and the second set of object parameters into a context-specific machine learning model configured to identify the one or more objects ranking highest according to their alignment with the features from both the first set of object parameters and the second set of object parameters.
6. The method of any of the preceding embodiments, wherein identifying the one or more objects comprises: receiving the first set of object parameters and the second set of object parameters; determining a set of objects, wherein each object of the set of objects is characterized by at least one object parameter comprised in both the first set of object parameters and the second set of object parameters; computing, for each object of the set of objects, a score based on a number of object parameters of each object comprised in both the first set of object parameters and the second set of object parameters; and identifying a subset of the set of objects based on the score of each object.
7. The method of any of the preceding embodiments, wherein identifying the one or more objects comprises: determining a first object set based on the objects characterized by at least one object parameter of the first set of object parameters; and determining the one or more objects by filtering the objects of the first object set based on whether or not each object of the first object set is characterized by the at least one object parameter of the second set of object parameters.
8. The method of any of the preceding embodiments, wherein identifying the one or more objects comprises: determining a third set of object parameters based on the object parameters comprised in both the first set of object parameters and the second set of object parameters; and selecting the one or more objects based on each object of the one or more objects being characterized by at least a threshold number of object parameters of the third set of object parameters.
9. The method of any of the preceding embodiments, wherein identifying the one or more objects comprises: determining at least one object parameter of the first set of object parameters is distinct from the object parameters of the second set of object parameters; and selecting the one or more objects based on the objects characterized by a highest number of object parameters of the first set of object parameters and the second set of object parameters.
10. The method of any of the preceding embodiments, wherein the focus parameter relates to a cyclical period of time, and/or is based on categories of inventory available.
11. One or more tangible, non-transitory, computer-readable media storing instructions that, when executed by a data processing apparatus, cause the data processing apparatus to perform operations comprising those of any of embodiments 1-10.
12. A system comprising: one or more processors; and memory storing instructions that, when executed by the one or more processors, cause the processors to effectuate operations comprising those of any of embodiments 1-10.
13. A system comprising means for performing any of embodiments 1-10.
14. A system comprising cloud-based circuitry for performing any of embodiments 1-10.

What is claimed is:

1. A system for training machine learning models based on previous user-element interactions, the system comprising:
one or more processors; and
one or more non-transitory, computer-readable media comprising instructions that, when executed by the one or more processors, cause operations comprising:
receiving a plurality of records comprising a set of features indicative of (a) user parameters for a plurality of users, (b) corresponding user-element interactions for each user parameter recorded during a period of time, wherein each feature comprises a plurality of values with each value corresponding to a record of the plurality of records, and (c) a focus parameter, wherein the focus parameter indicates a portion of the set of features for model concentration;
generating from the set of features (1) a first subset of the set of features, the first subset comprising concentrated features selected based on the focus parameter and generating from the set of features (2) a second subset of the set of features, the second subset comprising foundational features having values recorded over time that provide a baseline for a training dataset;
performing feature extraction using the first subset to obtain dynamic features representative of features that influenced user-element interactions associated with the focus parameter and performing the feature extraction using the second subset to obtain stable features representative of the features that influenced the user-element interactions;
training a first machine learning model using the dynamic features of the first subset of the set of features to identify object parameters associated with objects that users are likely to interact with based on user-element interactions associated with the focus parameter; and
training a second machine learning model using the stable features of the second subset of the set of features to identify the object parameters associated with the objects that the users are likely to interact with based on stable user-element interactions.

2. The system of claim 1, wherein the instructions further cause the one or more processors to perform operations including:
receiving a prediction request for a user, wherein the prediction request comprises parameters associated with the user;
inputting the parameters associated with the user into the first machine learning model to obtain a first set of object parameters based on a measure of likelihood of interaction by the user with each object corresponding to the first set of object parameters based on the dynamic features;
inputting the parameters associated with the user into the second machine learning model to obtain a second set of object parameters based on the measure of the likelihood of interaction by the user with each object corresponding to the second set of object parameters based on the stable features;
identifying, based on the first set of object parameters and the second set of object parameters, one or more objects for the user, wherein the one or more objects are identified using a combined determination based on alignment of object features associated with the one or more objects with predicted features from the first set of object parameters and the second set of object parameters; and
providing the one or more objects to the user.

3. The system of claim 2, wherein the instructions further cause the one or more processors to perform operations including:
transmitting a first command for generating and displaying an interactive interface for the one or more objects; and
responsive to receiving an indication of a first interaction of the user with an object of the one or more objects, transmitting a second command for modifying a field indicative of an availability of the object.

4. A method for identifying objects based on previous user-object interactions, the method comprising:
receiving a prediction request for a user, wherein the prediction request comprises parameters associated with the user;
inputting the parameters associated with the user into a first machine learning model to obtain a first set of object parameters based on a measure of likelihood of interaction by the user with each object corresponding to the first set of object parameters based on dynamic features, wherein the first machine learning model is trained using the dynamic features to identify object parameters associated with the objects that users are likely to interact with based on user-element interactions corresponding to a focus parameter, wherein the focus parameter indicates a portion of a set of features for model concentration;
inputting the parameters associated with the user into a second machine learning model to obtain a second set of object parameters based on the measure of the likelihood of interaction by the user with each object corresponding to the second set of object parameters based on stable features, wherein the second machine learning model is trained using the stable features to identify the object parameters associated with the objects that the users are likely to interact with based on stable user-element interactions;
identifying, based on the first set of object parameters and the second set of object parameters, one or more objects for the user, wherein the one or more objects are identified using a combined determination based on alignment of object features associated with the one or more objects with predicted features from the first set of object parameters and the second set of object parameters; and
providing the one or more objects to the user.

5. The method of claim 4, further comprising:
transmitting a first command for generating and displaying an interactive interface for the one or more objects; and
responsive to receiving an indication of a first interaction of the user with an object of the one or more objects, transmitting a second command for modifying a field indicative of an availability of the object.

6. The method of claim 4, wherein the dynamic features and the stable features are obtained through feature extraction comprising:
receiving a plurality of records comprising a set of features indicative of (a) user parameters for a plurality of users, (b) corresponding user-element interactions for each user parameter recorded during a period of time, wherein each feature comprises a plurality of values with each value corresponding to a record of the plurality of records, and (c) the focus parameter;
generating from the set of features (1) a first subset of the set of features, the first subset comprising concentrated features associated with focus parameter and generating from the set of features (2) a second subset of the set of features, the second subset comprising foundational features; and
performing feature extraction using the first subset to obtain dynamic features representative of features that influenced user-element interactions associated with the focus parameter and performing the feature extraction using the second subset to obtain stable features representative of the features that influenced the user-element interactions that are non-specific to any one topic.

7. The method of claim 6, further comprising:
training a first machine learning model using the dynamic features of the first subset of the set of features to identify object parameters associated with the objects that users are likely to interact with based on user-element interactions associated with the focus parameter; and
training a second machine learning model using the stable features of the second subset of the set of features to identify the object parameters associated with the objects that the users are likely to interact with based on stable user-element interactions.

8. The method of claim 6, wherein identifying the one or more objects for the user comprises inputting the first set of object parameters and the second set of object parameters into a context-specific machine learning model configured to identify the one or more objects ranking highest according to their alignment with the features from both the first set of object parameters and the second set of object parameters.

9. The method of claim 6, wherein identifying the one or more objects comprises:
receiving the first set of object parameters and the second set of object parameters;
determining a set of objects, wherein each object of the set of objects is characterized by at least one object parameter comprised in both the first set of object parameters and the second set of object parameters;
computing, for each object of the set of objects, a score based on a number of object parameters of each object comprised in both the first set of object parameters and the second set of object parameters; and
identifying a subset of the set of objects based on the score of each object.

10. The method of claim 6, wherein identifying the one or more objects comprises:
determining a first object set based on the objects characterized by at least one object parameter of the first set of object parameters; and
determining the one or more objects by filtering the objects of the first object set based on whether or not each object of the first object set is characterized by the at least one object parameter of the second set of object parameters.

11. The method of claim 6, wherein identifying the one or more objects comprises:
determining a third set of object parameters based on the object parameters comprised in both the first set of object parameters and the second set of object parameters; and
selecting the one or more objects based on each object of the one or more objects being characterized by at least a threshold number of object parameters of the third set of object parameters.

12. The method of claim 6, wherein identifying the one or more objects comprises:
determining at least one object parameter of the first set of object parameters is distinct from the object parameters of the second set of object parameters; and
selecting the one or more objects based on the objects characterized by a highest number of object parameters of the first set of object parameters and the second set of object parameters.

13. The method of claim 6, wherein the focus parameter relates to a cyclical period of time, and/or is based on categories of inventory available.

14. One or more non-transitory, computer-readable media comprising instructions recorded thereon that, when executed by one or more processors, cause operations for identifying objects based on previous user-element interactions, comprising:
receiving a prediction request for a user, wherein the prediction request comprises parameters associated with the user;
inputting the parameters associated with the user into a first machine learning model to obtain a first set of object parameters based on a measure of likelihood of interaction by the user with each object corresponding to the first set of object parameters based on dynamic features, wherein the first machine learning model is trained using the dynamic features to identify object parameters associated with the objects that users are likely to interact with based on user-element interactions corresponding to a focus parameter, wherein the focus parameter indicates a portion of a set of features for model concentration;
inputting the parameters associated with the user into a second machine learning model to obtain a second set of object parameters based on the measure of the likelihood of interaction by the user with each object corresponding to the second set of object parameters based on stable features, wherein the second machine learning model is trained using the stable features to identify the object parameters associated with the objects that the users are likely to interact with based on stable user-element interactions;
identifying, based on the first set of object parameters and the second set of object parameters, one or more objects for the user, wherein the one or more objects are identified using a combined determination based on alignment of object features associated with the one or more objects with predicted features from the first set of object parameters and the second set of object parameters; and
providing the one or more objects to the user.

15. The one or more non-transitory, computer-readable media of claim 14, wherein the instructions further cause operations comprising:
transmitting a first command for generating and displaying an interactive interface for the one or more objects; and
responsive to receiving an indication of a first interaction of the user with an object of the one or more objects, transmitting a second command for modifying a field indicative of an availability of the object.

16. The one or more non-transitory, computer-readable media of claim 14, wherein the dynamic features and the stable features are obtained through feature extraction comprising:
receiving a plurality of records comprising a set of features indicative of (a) user parameters for a plurality of users, (b) corresponding user-element interactions for each user parameter recorded during a period of time, wherein each feature comprises a plurality of values with each value corresponding to a record of the plurality of records, and (c) the focus parameter;
generating from the set of features (1) a first subset of the set of features, the first subset comprising concentrated features associated with focus parameter and generating from the set of features (2) a second subset of the set of features, the second subset comprising foundational features; and
performing feature extraction using the first subset to obtain dynamic features representative of features that influenced user-element interactions associated with the focus parameter and performing the feature extraction using the second subset to obtain stable features representative of the features that influenced the user-element interactions that are non-specific to any one topic.

17. The one or more non-transitory, computer-readable media of claim 16, wherein the instructions further cause operations comprising:
training a first machine learning model using the dynamic features of the first subset of the set of features to identify object parameters associated with the objects that users are likely to interact with based on user-element interactions associated with the focus parameter; and
training a second machine learning model using the stable features of the second subset of the set of features to identify the object parameters associated with the objects that the users are likely to interact with based on stable user-element interactions.

18. The one or more non-transitory, computer-readable media of claim 16, wherein identifying the one or more objects for the user comprises inputting the first set of object parameters and the second set of object parameters into a context-specific machine learning model configured to identify the one or more objects ranking highest according to their alignment with the features from both the first set of object parameters and the second set of object parameters.

19. The one or more non-transitory, computer-readable media of claim 16, wherein identifying the one or more objects comprises:
receiving the first set of object parameters and the second set of object parameters;
determining a set of objects, wherein each object of the set of objects is characterized by at least one object parameter comprised in both the first set of object parameters and the second set of object parameters;
computing, for each object of the set of objects, a score based on a number of object parameters of each object comprised in both the first set of object parameters and the second set of object parameters; and
identifying a subset of the set of objects based on the score of each object.

20. The one or more non-transitory, computer-readable media of claim 16, wherein identifying the one or more objects comprises:
determining a first object set based on the objects characterized by at least one object parameter of the first set of object parameters; and
determining the one or more objects by filtering the objects of the first object set based on whether or not each object of the first object set is characterized by the at least one object parameter of the second set of object parameters.
